(19) United States
(12) Patent Application Publication
(10) Pub. No.: US 2012/0105502 A1
(43) Pub. Date: May 3, 2012

(54) IMAGE DISPLAY DEVICE AND CONTROL METHOD THEREOF

(76) Inventors: Junichi YOKOYAMA, Fujisawa (JP); Masami Iseki, Yokohama (JP); Fujio Kawano, Kawasaki (JP)

(21) Appl. No.: 13/282,581

(22) Filed: Oct. 27, 2011

(30) Foreign Application Priority Data
Oct. 27, 2010 (JP) 2010-241415

(51) Int. Cl. G09G 5/10

(52) U.S. Cl. 345/690

(57) ABSTRACT

Provided is an image display device capable of dynamically controlling the D-V characteristics of a display panel while suppressing fluctuation in characteristic for each display panel. The display panel has a panel display portion including a red pixel, a green pixel, and a blue pixel. A storage unit stores V-L characteristic data measured in advance of RGB. A D-L calculation unit calculates D-L characteristic data of RGB based on the display setting values stored in a register. A D-V calculation unit calculates D-V characteristic data of RGB based on the V-L characteristic data stored in the storage unit and the D-L characteristic data calculated by the D-L calculation unit. A DAC generates a driving voltage corresponding to a video signal input from a timing controller based on the D-V characteristic data calculated by the D-V calculation unit and applies the driving voltage to each pixel.

### CROSS-REFERENCE TO RELATED APPLICATION

The present application claims priority from Japanese application JP 2010-241415 filed on Oct. 27, 2010, the content of which is hereby incorporated by reference into this application.

### BACKGROUND OF THE INVENTION

1. Field of the Invention

The present invention relates to an image display device and a control method thereof.

2. Description of the Related Art

In the related art, an image display device including a display panel which has organic light-emitting diodes (OLED) elements and thin film transistors (TFT) is known. In this type of image display device, in order to suppress fluctuation of emission properties of OLED elements and I-V characteristics (driving current-driving voltage characteristics) of TFTs, it is desirable to adjust white balance (WB) and a gamma value for each display panel.

For example, a method of adjusting the operation properties of a digital/analog converter (DAC: D/A converter) for each display panel, for outputting a driving voltage V corresponding to a video signal (gradation signal) D input from the outside during manufacturing or shipping of an image display device is known. Specifically, a driving voltage V relative to a video signal D is measured for each display panel, and D-V characteristic data representing the relationship thereof are stored in advance in a DAC setting register of each display panel as initial parameters. By doing so, the driving voltage V of each display panel is determined based on the D-V characteristic data stored in the DAC setting register, and the characteristic fluctuation of the display panels is suppressed.

Japanese Patent No. 4046617 discloses an organic EL driving circuit and an organic EL display device capable of preventing a collapse of white balance due to temporal changes without monitoring the operation time of the display device.

### SUMMARY OF THE INVENTION

However, in an image display device adjusted by the above method, since the D-V characteristic data set in the DAC setting register before shipping are used as they are, it is not possible to dynamically control the D-V characteristics of a display panel in accordance with changes in display settings (gamma value, maximum luminance, minimum luminance, and the like) by users, changes in the use environment, and the like.

The present invention has been made in view of the above problems, and an object of the present invention is to provide an image display device and a control method thereof capable of dynamically controlling the D-V characteristics of a display panel while suppressing fluctuation in characteristic for each display panel.

In order to solve the above problems, an image display device according to an aspect of the present invention includes a display panel having a display region in which a plurality of pixels including a red (R) pixel, a green (G) pixel, and a blue (B) pixel are arranged; a measurement value storage unit that stores V-L characteristic data representing the characteristics measured in advance of luminance against a driving voltage of the display panel; a V-L acquisition unit that acquires V-L characteristic data of the respective colors RGB based on the V-L characteristic data stored in the measurement value storage unit; a setting value storage unit that stores display setting values for setting display attributes of the display panel; a D-L calculation unit that calculates D-L characteristic data for the respective colors RGB, representing the characteristics of luminance against a gradation of the display panel based on the display setting values stored in the setting value storage unit; a D-V calculation unit that calculates D-V characteristic data for the respective colors RGB, representing the characteristics of a driving voltage against the gradation of the display panel based on the V-L characteristic data of the respective colors RGB acquired by the V-L acquisition unit and the D-L characteristic data of the respective colors RGB calculated by the D-L calculation unit; and a driving voltage generation unit that generates a driving voltage corresponding to a video signal input from the outside based on the D-V characteristic data of the respective colors RGB calculated by the D-V calculation unit and applies the driving voltage to each of the plurality of pixels.

In the above aspect of the present invention, the V-L characteristic data of the display panel for each device are measured in advance and stored. Moreover, the D-V characteristic data of the respective colors RGB are calculated based on the V-L characteristic data and D-L characteristic data of the respective colors calculated based on display setting values. Thus, according to the above aspect of the present invention, it is possible to dynamically control the D-V characteristics of the display panel in accordance with changes in the display setting value while suppressing fluctuation in characteristic for each display panel.

In an embodiment of the present invention, the measurement value storage unit may store data representing the characteristics measured in advance of luminances of the respective colors RGB against the driving voltage of the display panel as the V-L characteristic data, and the V-L acquisition unit may acquire the V-L characteristic data stored in the measurement value storage unit as the V-L characteristic data of the respective colors RGB.

In another embodiment of the present invention, the image display device may further include a luminance rate acquisition unit that acquires RGB luminance rates representing the rates of the luminances of the respective colors RGB to that of white of the display panel, the measurement value storage unit may store data representing the characteristics measured in advance of the luminance of white against the driving voltage of the display panel as the V-L characteristic data, and the V-L acquisition unit may calculate the V-L characteristic data of the respective colors RGB based on the data representing the characteristics of the luminance of white against the driving voltage of the display panel stored in the measurement value storage unit and the RGB luminance rates acquired by the luminance rate acquisition unit.

In yet another embodiment of the present invention, the image display device may further include a deterioration amount calculation unit that calculates luminance deterioration amounts of the respective colors RGB of the display panel, and the V-L acquisition unit may correct the V-L characteristic data of the respective colors RGB based on the luminance deterioration amounts of the respective colors RGB calculated by the deterioration amount calculation unit.

According to this embodiment, it is possible to reflect the luminance deterioration amounts of the display panel in the D-V characteristics of the display panel, which are controlled dynamically.

In yet another embodiment of the present invention, the deterioration amount calculation unit may calculate the luminance deterioration amounts of the respective colors RGB based on the product of the video signal and a driving time of the display panel.

In this embodiment, the driving time of the display panel may be a lighting time of the display panel or a power-ON time of the image display device.

In yet another embodiment of the present invention, the image display device may further include a temperature detection unit that detects an ambient temperature of the display panel, and the V-L acquisition unit may correct the V-L characteristic data of the respective colors RGB based on the ambient temperature detected by the temperature detection unit.

According to this embodiment, it is possible to reflect temperature dependence of the display panel in the D-V characteristics of the display panel, which are controlled dynamically.

In yet another embodiment of the present invention, the V-L acquisition unit may correct the V-L characteristic data of the respective colors RGB based on an emission period when measuring the V-L characteristics of the display panel and a present emission period of the display panel.

In yet another embodiment of the present invention, the image display device may further include a luminance rate acquisition unit that acquires RGB luminance rates representing the rates of the luminances of the respective colors RGB to that of white of the display panel, the setting value storage unit may store at least a gamma value, the maximum luminance, and the minimum luminance as the display setting values, and the D-L calculation unit may calculate the D-L characteristic data of the respective colors RGB based on the data representing the characteristics of the luminance of white against the gradation of the display panel, calculated based on the gamma value, the maximum luminance and the minimum luminance stored in the setting value storage unit and the RGB luminance rates acquired by the luminance rate acquisition unit.

In yet another embodiment of the present invention, the setting value storage unit may further store a color temperature of white and chromaticities of the respective colors RGB, and the luminance rate acquisition unit may calculate the RGB luminance rates based on the color temperature of white and the chromaticities of the respective colors RGB stored in the setting value storage unit.

In yet another embodiment of the present invention, the D-L calculation unit may recalculate the D-L characteristic data of the respective colors RGB at the time when any one of the display setting values stored in the setting value storage unit is changed.

In yet another embodiment of the present invention, the driving voltage generation unit may be a D/A converter that operates in accordance with the content set in a setting register, and the D-V calculation unit may set the calculated D-V characteristic data of the respective colors RGB in the setting register.

In yet another embodiment of the present invention, each of the plurality of pixels may include an organic light-emitting diode element.

A control method of an image display device according to another aspect of the present invention is a control method of an image display device which includes a display panel having a display region in which a plurality of pixels including a red (R) pixel, a green (G) pixel, and a blue (B) pixel are arranged, including: storing V-L characteristic data representing the characteristics measured in advance of luminance against a driving voltage of the display panel in a measurement value storage unit; acquiring V-L characteristic data of the respective colors RGB based on the V-L characteristic data stored in the measurement value storage unit; storing display setting values for setting display attributes of the display panel in a setting value storage unit; calculating D-L characteristic data for the respective colors RGB, representing the characteristics of luminance against a gradation of the display panel based on the display setting values stored in the setting value storage unit; calculating D-V characteristic data for the respective colors RGB, representing the characteristics of a driving voltage against the gradation of the display panel based on the V-L characteristic data of the respective colors RGB and the D-L characteristic data of the respective colors RGB; and generating a driving voltage corresponding to a video signal input from the outside based on the D-V characteristic data of the respective colors RGB and applying the driving voltage to each of the plurality of pixels.

### BRIEF DESCRIPTION OF THE DRAWINGS

FIG. 1 is a diagram showing a configuration of an image display device according to first to sixth embodiments of the present invention.

FIG. 2 is a block diagram of a signal line control circuit according to the first embodiment of the present invention.

FIG. 3 is a diagram showing an example of the V-L characteristics of each of the colors RGB in a display panel.

FIG. 4 is a diagram showing an example of the D-L characteristics of each of the colors RGBW in the display panel.

FIG. 5A is a diagram showing an example of the D-V characteristics of the color R in the display panel.

FIG. 5B is a diagram showing an example of the D-V characteristics of the color G in the display panel.

FIG. 5C is a diagram showing an example of the D-V characteristics of the color B in the display panel.

FIG. 6A is a diagram showing changes with register value, of the D-V characteristics of the color R shown in FIG. 5A.

FIG. 6B is a diagram showing changes with register value, of the D-V characteristics of the color G shown in FIG. 5B.

FIG. 6C is a diagram showing changes with register value, of the D-V characteristics of the color B shown in FIG. 5C.

FIG. 7 is a block diagram of a signal line control circuit according to the second embodiment of the present invention.

FIG. 8 is a block diagram of a signal line control circuit according to the third embodiment of the present invention.

FIG. 9 is a block diagram of a signal line control circuit according to the fourth embodiment of the present invention.

FIG. 10 is a block diagram of a signal line control circuit according to the fifth embodiment of the present invention.

FIG. 11 is a diagram showing an example of the relationship between APL and maximum luminance.

FIG. 12 is a block diagram of a signal line control circuit according to the sixth embodiment of the present invention.

### DETAILED DESCRIPTION OF THE INVENTION

Hereinafter, first to sixth embodiments of the present invention will be described in detail with reference to the drawings. In the embodiments, it is assumed that an image display device includes an organic EL panel as a display panel.

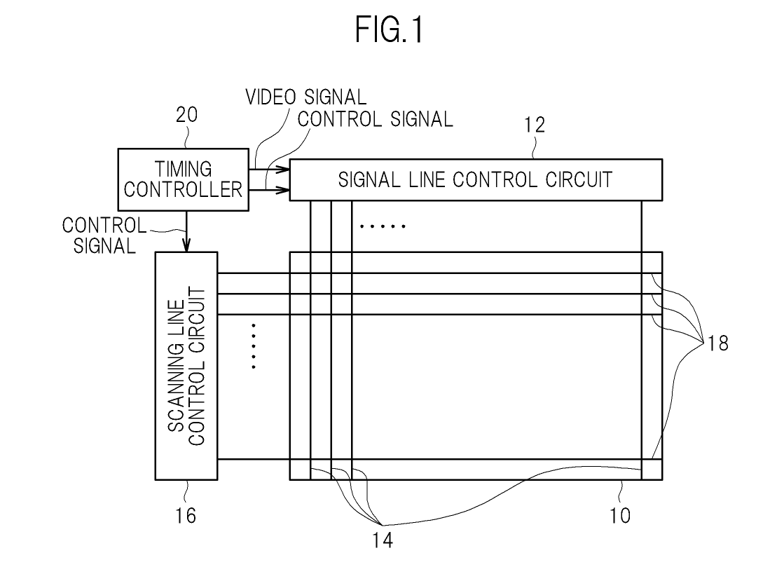

FIG. 1 is a diagram showing a configuration of an image display device according to the first to sixth embodiments of the present invention. As shown in FIG. 1, the image display device includes a display panel in which a panel display portion 10 is used as a display region, a signal line control circuit 12, a plurality of data lines 14, a scanning line control circuit 16, a plurality of scanning lines 18, a timing controller 20, and a register 22 (not shown).

The panel display portion 10 is a display region of a display panel in which a plurality of pixels including red (R) pixels, green (G) pixels, and blue (B) pixels are arranged in a matrix form. These pixels each include an OLED element that emits light at a luminance corresponding to an applied driving voltage and a TFT which is an OLED driving circuit. The TFT includes a switch element that switches the OLED element on and off, a capacitor that holds a driving voltage value corresponding to a gradation signal, and a current driving element that supplies a driving current corresponding to the driving voltage value held in the capacitor to the OLED element.

In the panel display portion 10, a plurality of scanning lines 18 are formed along the pixels which are arranged in the horizontal direction (X direction). The respective scanning lines 18 are connected to the switching elements included in the pixels arranged along the scanning lines 18 so as to transfer an ON/OFF voltage for determining lighting and non-lighting supplied from the scanning line control circuit 16 to the respective pixels.

Moreover, in the panel display portion 10, a plurality of data lines 14 are formed along the pixels which are arranged in the vertical direction (Y direction). The respective data lines 14 are connected to the switching elements of the pixels arranged along the data lines 14 so as to transfer a driving voltage corresponding to the gradation signal supplied from the signal line control circuit 12 to the respective pixels.

The timing controller 20 outputs control signals for giving an instruction on the time for the scanning line control circuit 16 to select the scanning line 18 corresponding to a pixel to be controlled and outputs control signals for giving an instruction on the time for the signal line control circuit 12 to select the data line 14 corresponding to the pixel to be controlled. Moreover, the timing controller 20 outputs video signals to the signal line control circuit 12.

The scanning line control circuit 16 selects the corresponding scanning line 18 in accordance with the control signals from the timing controller 20. When a switching element included in the pixel connected to the scanning line 18 is turned ON, a driving voltage is supplied from the signal line control circuit 12 through the data line 14 connected to the switching element of the pixel. The driving voltage value is stored in a capacitor through the switching element. Moreover, a driving current corresponding to the voltage value is supplied to an OLED element from a current supply line (not shown) through the current driving element until the voltage value held in the capacitor is rewritten. Then, the OLED element emits light at a luminance corresponding to the magnitude of the driving current.

The register 22 stores display setting values for setting the display attributes of the display panel. These display setting values are frequently changed in accordance with changes in settings by users, changes in the use environment, and the like. In the first to sixth embodiments, it is assumed that the register 22 stores at least a gamma value, maximum luminance, minimum luminance, the color temperature (chromaticity) of white, and the chromaticities of the respective colors RGB as the display setting values.

Next, an internal configuration of the signal line control circuit 12 will be described in detail with respect to the first to sixth embodiments.

### First Embodiment

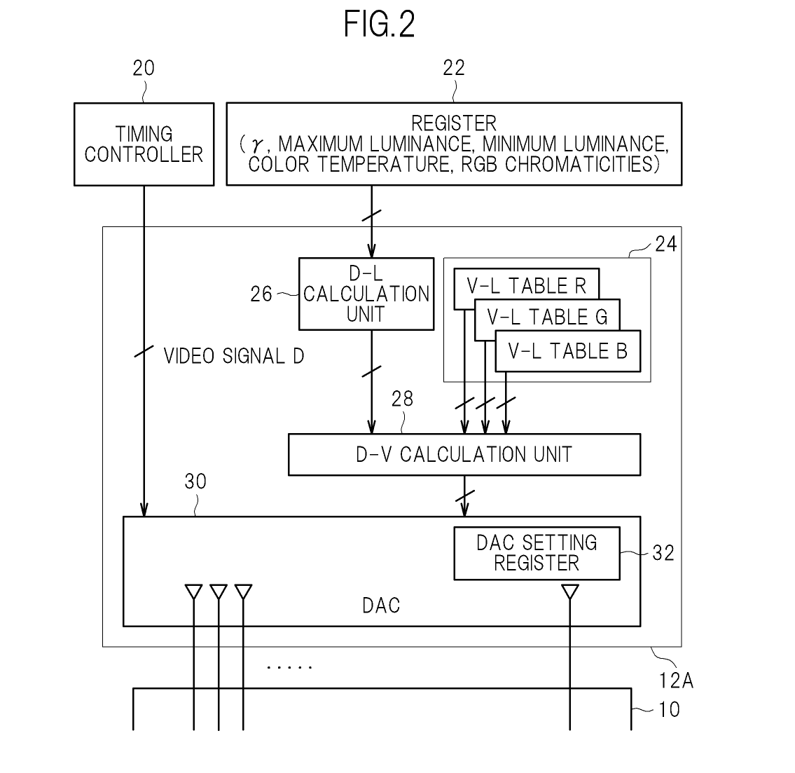

FIG. 2 is a block diagram of a signal line control circuit 12A according to the first embodiment of the present invention. As shown in FIG. 2, the signal line control circuit 12A includes a storage unit 24, a D-L calculation unit 26, a D-V calculation unit 28, and a DAC 30.

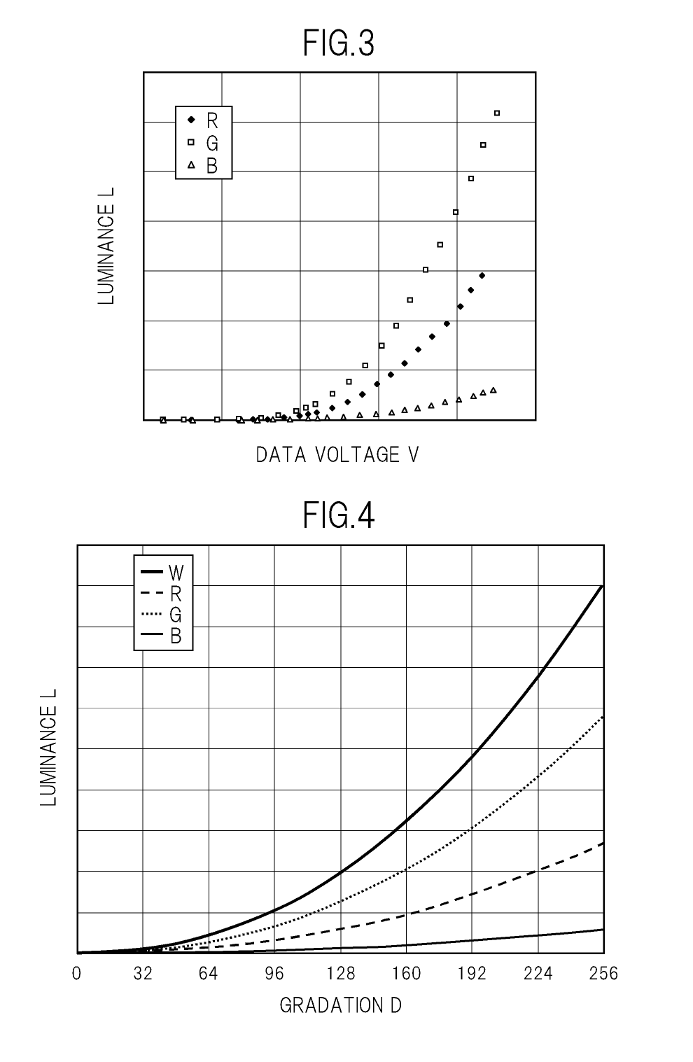

The storage unit 24 is configured by a semiconductor memory element, for example, and stores V-L characteristic data representing the characteristics (V-L characteristics) measured in advance, of luminance against a driving voltage (source driver output) of a display panel. The V-L characteristics are measured in units of lots for each display panel during manufacturing or shipping of an image display device, and data acquired through the measurement are written to the storage unit 24. In the present embodiment, the storage unit 24 stores a V-L table R representing the V-L characteristics of red, a V-L table G representing the V-L characteristic of green, and a V-L table B representing the V-L characteristics of blue as the V-L characteristic data of the respective colors RGB (see FIG. 3).

The storage unit 24 may store a mathematical equation which approximates the V-L characteristics and constants substituted into the mathematical equation as the V-L characteristic data instead of the lookup table. For example, if the relationship between a driving voltage V and a luminance L has square characteristics, the storage unit 24 may store Equation (1) below and constants α and β reflecting the measurement values of the V-L characteristics as the V-L characteristic data.

L=α×V²+β (1)

The D-L calculation unit 26 calculates D-L characteristic data for the respective colors RGB, representing the characteristics (D-L characteristics) of luminance against a gradation of the display panel based on the display setting values (gamma value, maximum luminance, minimum luminance, color temperature of white, chromaticities of the respective colors RGB) stored in the register 22. For example, the D-L calculation unit 26 calculates a W luminance (D) which is characteristic data representing the luminance of white against a gradation D of the display panel based on Equation (2) and calculates RGB luminance rates Rrate, Grate, and Brate representing the rates of luminances of the respective colors RGB to the luminance of white of the display panel based on Equation (3). In the equations, γ represents a gamma value, and X, Y, and Z represent the chromaticities (tristimulus values) of the respective colors WRGB.

W Luminance(D)=(Maximum Luminance)×(D/255)^{γ}+(Minimum Luminance) (2)

$$( \begin{matrix}{X}_{W} \\ {Y}_{W} \\ {Z}_{W}\end{matrix} ) = ( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ) \times ( \begin{matrix}Rrate \\ Grate \\ Brate\end{matrix} ) \qquad ( 3 )$$

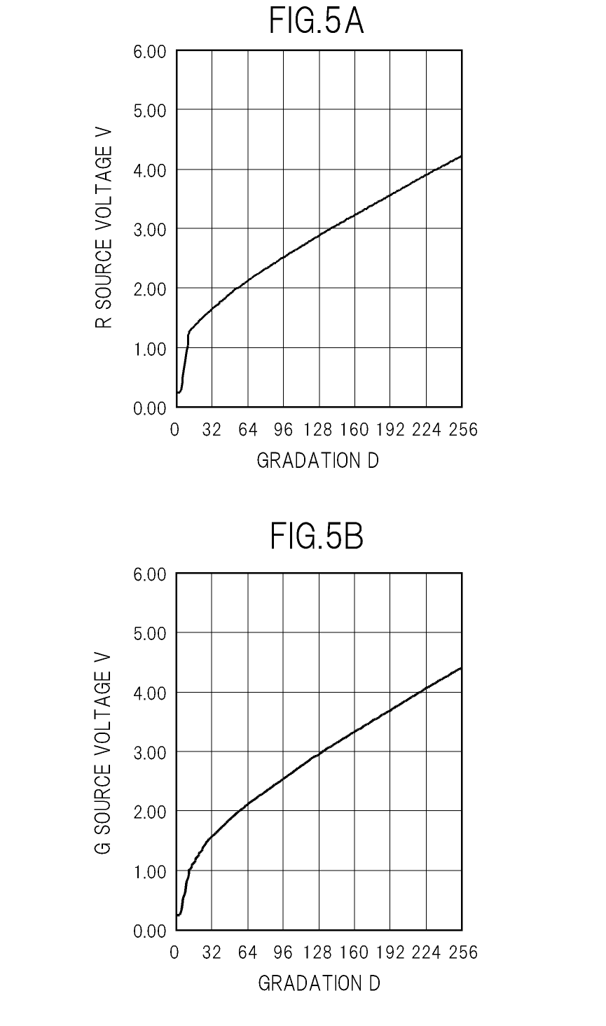

The D-L calculation unit 26 calculates R luminance (D), G luminance (D), and B luminance (D) which are D-L characteristic data representing the luminances of the respective colors RGB against the gradation D based on the W luminance (D) calculated by Equation (2) and the Rrate, Grate, and Brate calculated by Equation (3) (see FIG. 4). Specifically, the R luminance (D) is obtained by multiplying Rrate to W luminance (D), the G luminance (D) is obtained by multiplying Grate to W luminance (D), and the B luminance (D) is obtained by multiplying Brate to W luminance (D). The W luminance (D), R luminance (D), G luminance (D), and B luminance (D) satisfy the relation of Equation (4).

W Luminance(D)=(R Luminance(D))+(G Luminance(D))+(B Luminance(D)) (4)

Naturally, the D-L calculation unit 26 may calculate the W luminance (D) by another method without being limited to Equation (2). For example, the W luminance (D) may be calculated by Equation (5) below, and in this case, parameters necessary for calculating the W luminance (D) by Equation (5) may be stored in the register as the display setting values. In the equation, f is a predetermined function that defines the relationship between the W luminance (D), the gamma value γ, and the gradation D.

W Luminance(D)=f(γ,D) (5)

Similarly, the D-L calculation unit 26 may acquire the RGB luminance rates by another method without being limited to Equation (3). For example, the RGB luminance rates Rrate, Grate, and Brate may be stored in advance in the register 22 as the display setting values, and the D-L calculation unit 26 may read the RGB luminance rates Rrate, Grate, and Brate stored in the register 22 as they are.

Furthermore, the R luminance (D), G luminance (D), and B luminance (D) which are D-L characteristic data of the respective colors RGB may be stored in advance in the register 22 as the display setting values, and the D-L calculation unit 26 may read the R luminance (D), G luminance (D), and B luminance (D) stored in the register 22 as they are.

When the display setting values stored in the register 22 are changed with changes in settings by users, changes in the use environment, and the like, it is desirable for the D-L calculation unit 26 to recalculate the D-L characteristic data of the respective colors RGB at the time when any one of the display setting values is changed.

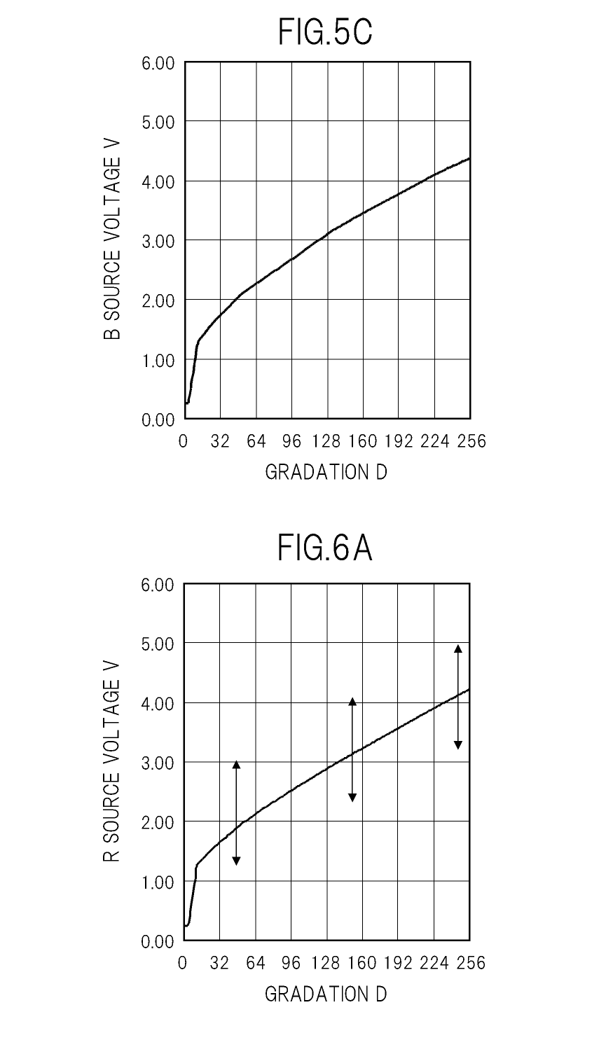

The D-V calculation unit 28 calculates D-V characteristic data for the respective colors RGB, representing the characteristics of the driving voltage V against the gradation D of the display panel (see FIGS. 5A to 5C) based on the V-L table R, V-L table G, and V-L table B (see FIG. 3) which are V-L characteristic data of the respective colors RGB stored in the storage unit 24 and the R luminance (D), G luminance (D), and B luminance (D) (see FIG. 4) which are D-L characteristic data of the respective colors RGB calculated by the D-L calculation unit 26. Here, the D-V calculation unit 28 may appropriately interpolate the V-L characteristic data of the respective colors RGB and the D-L characteristic data of the respective colors RGB and use the interpolation results. Moreover, the D-V calculation unit 28 sets the calculated D-V characteristic data of the respective colors RGB in a DAC setting register 32 of the DAC 30.

The DAC 30 includes the DAC setting register 32 and is a driving voltage generation means that operates in accordance with the content set in the DAC setting register 32. Specifically, the DAC 30 generates an analog driving voltage corresponding to a digital video signal (gradation signal) D input from the timing controller 20 based on the D-V characteristic data of the respective colors RGB set in the DAC setting register 32 and applies the driving voltage to a plurality of pixels (R pixel, G pixel, and B pixel) arranged in the panel display portion 10 through the plurality of data lines 14.

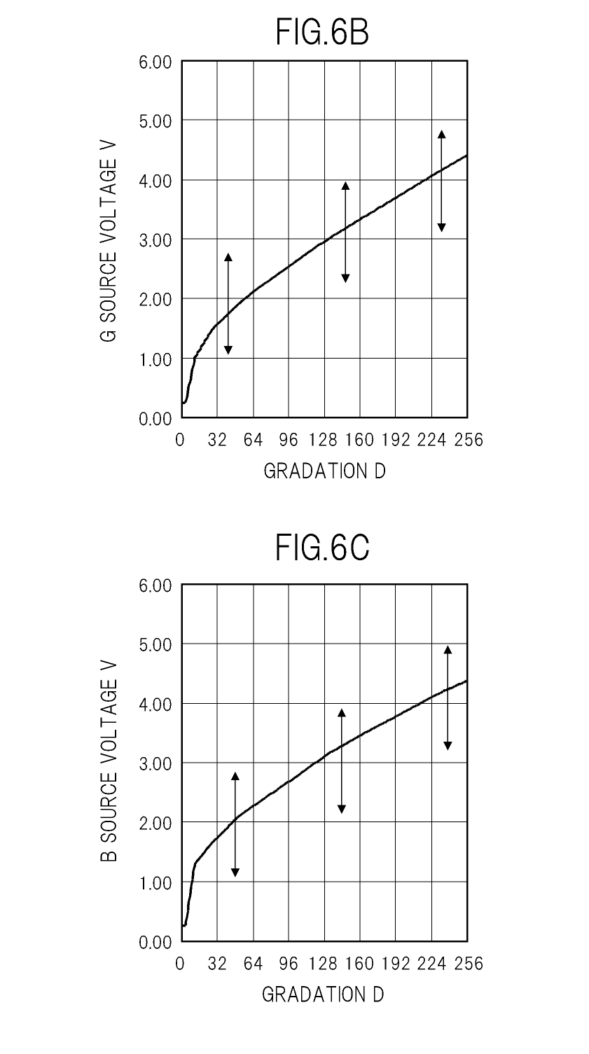

As above, the display setting values stored in the register 22 are frequently changed with changes in settings by users, changes in the use environment, and the like. When any one of the display setting values is changed, since the D-L characteristic data of the respective colors RGB calculated by the D-L calculation unit 26 are accordingly changed, the D-V characteristic data of the respective colors RGB calculated by the D-V calculation unit 28 are also changed (see FIGS. 6A to 6C). Moreover, the V-L characteristic data measured in advance of the display panel, stored in the storage unit 24 are reflected in the D-V characteristic data of the respective colors RGB calculated by the D-V calculation unit 28.

Therefore, according to the present embodiment, it is possible to dynamically control the D-V characteristics of the display panel while suppressing fluctuation in characteristic for each display panel. For example, since the D-V characteristics of the display panel can be controlled dynamically by adjusting the maximum luminance among the display setting values stored in the register 22, pulse amplitude modulation (PAM) can be applied to the adjustment of luminance of the OLED display panel in which in general, pulse width modulation (PWM) was used. In this way, it is possible to extend the emission time of the OLED element and decrease the peak current of the OLED element at low luminance to thereby reduce a load on the circuits.

### Second Embodiment

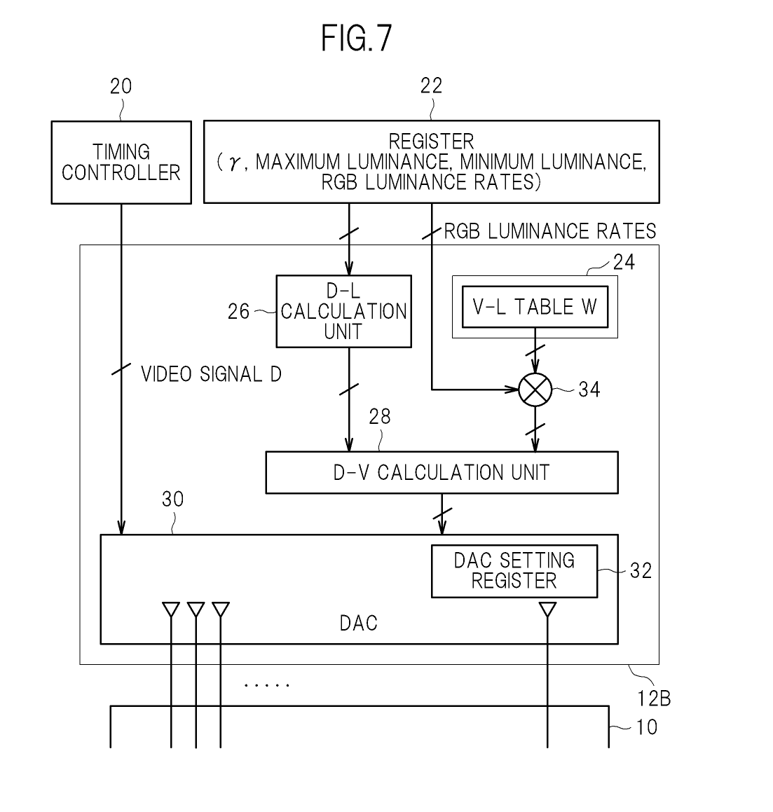

FIG. 7 is a block diagram of a signal line control circuit 12B according to the second embodiment of the present invention. As shown in FIG. 7, the signal line control circuit 12B includes a storage unit 24, a D-L calculation unit 26, a D-V calculation unit 28, a DAC 30, and a multiplier 34.

The signal line control circuit 12B is different from the signal line control circuit 12A according to the first embodiment, in that the configuration of acquiring the V-L characteristic data of the respective colors RGB is different. Specifically, the content stored in the register 22 and the content stored in the storage unit 24 are different from those of the signal line control circuit 12A. Moreover, the multiplier 34 is added to the signal line control circuit 12A.

In the present embodiment, the storage unit 24 stores only the V-L characteristic data W representing the characteristics measured in advance, of the luminance of white to the driving voltage of the display panel as the V-L characteristic data of the display panel. Moreover, the register 22 stores the RGB luminance rates Rrate, Grate, and Brate representing the rates of the luminances of the respective colors RGB to that of white of the display panel as the display setting values. The RGB luminance rates are set by calculating outside the display panel from chromaticity data and desired color temperature of the respective colors RGB during inspection when shipping, for example. When there is a plurality of desired color temperatures, the plurality of color temperatures may be set in the register 22. Alternatively, if the luminance rate changes with gradation, data for each gradation may be set in the register 22.

The multiplier 34 multiplies the V-L characteristic data W stored in the storage unit 24 and the RGB luminance rates Rrate, Grate, and Brate stored in the register 22, respectively. Here, the V-L table R representing the V-L characteristics of red is obtained by multiplying Rrate to the V-L characteristic data W, the V-L table G representing the V-L characteristics of green is obtained by multiplying Grate to the V-L characteristic data W, and the V-L table B representing the V-L characteristics of blue is obtained by multiplying Brate to the V-L characteristic data W (see FIG. 3). Moreover, the multiplier 34 outputs the V-L characteristic data of the respective colors RGB obtained in this way to the D-V calculation unit 28.

The D-V calculation unit 28 calculates D-V characteristic data of the respective colors RGB (see FIGS. 5A to 5C) based on the V-L table R, V-L table G, and V-L table B (see FIG. 3) which are V-L characteristic data of the respective colors RGB input from the multiplier 34 and the R luminance (D), G luminance (D), and B luminance (D) (see FIG. 4) which are D-L characteristic data of the respective colors RGB calculated by the D-L calculation unit 26. The other configurations are the same as those of the first embodiment.

Similarly to the first embodiment, the display setting values stored in the register 22 are frequently changed with changes in settings by users, changes in the use environment, and the like. When any one of the display setting values is changed, since the D-L characteristic data of the respective colors RGB calculated by the D-L calculation unit 26 are accordingly changed, the D-V characteristic data of the respective colors RGB calculated by the D-V calculation unit 28 are also changed (see FIGS. 6A to 6C). Moreover, the V-L characteristic data measured in advance of the display panel, stored in the storage unit 24 are reflected in the D-V characteristic data of the respective colors RGB calculated by the D-V calculation unit 28.

Therefore, according to the present embodiment, similarly to the first embodiment, it is also possible to dynamically control the D-V characteristics of the display panel while suppressing fluctuation in characteristic for each display panel.

### Third Embodiment

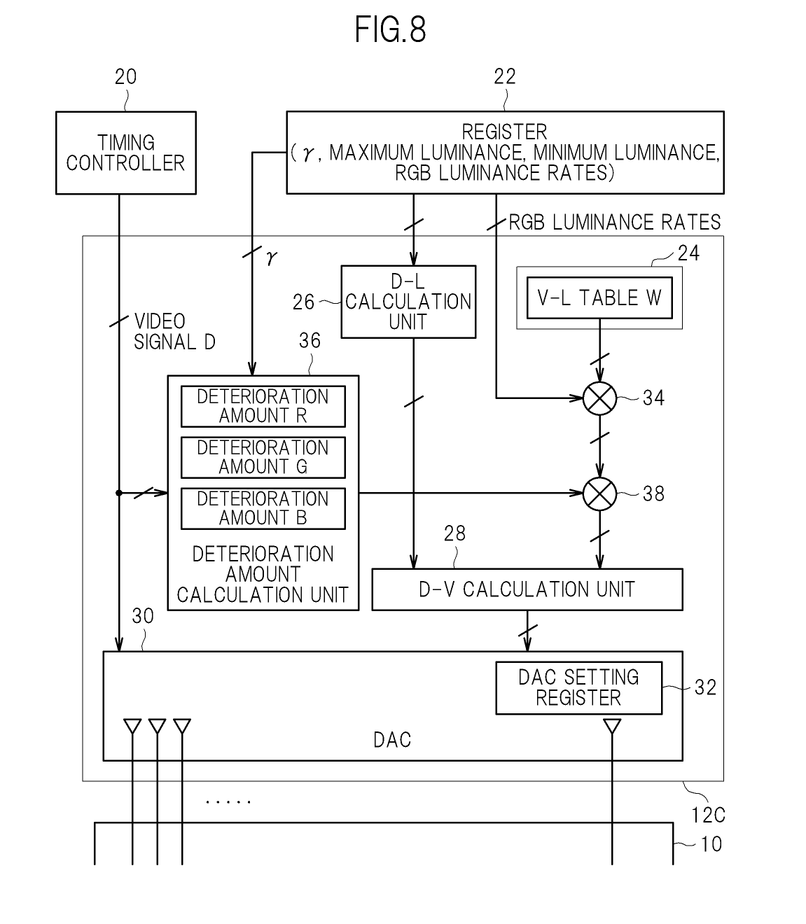

FIG. 8 is a block diagram of a signal line control circuit 12C according to the third embodiment of the present invention. As shown in FIG. 8, the signal line control circuit 12C includes a storage unit 24, a D-L calculation unit 26, a D-V calculation unit 28, a DAC 30, multipliers 34 and 38, and a deterioration amount calculation unit 36.

The signal line control circuit 12C is different from the signal line control circuit 12B according to the second embodiment, in that the configuration of acquiring the V-L characteristic data of the respective colors RGB is different. Specifically, the deterioration amount calculation unit 36 and the multiplier 38 are added to the signal line control circuit 12B.

The deterioration amount calculation unit 36 calculates the luminance deterioration amounts of the respective colors RGB in the display panel. Temporal deterioration is substantially proportional to the product of driving current (luminance) and time. Thus, the deterioration amount calculation unit 36 may calculate the luminance deterioration amounts of the respective colors RGB based on the product of a video signal and a driving time of the display panel.

For example, the deterioration amount calculation unit 36 can calculate the deterioration amount R, deterioration amount G, deterioration amount B which are the luminance deterioration amounts of the respective colors RGB by calculating the sum of the RGB luminances of respective frames using a video signal D and a gamma value γ and adding the sum every frame as shown in Equations (6), (7), and (8) below.

Deterioration Amount R(T+1)=Deterioration Amount R(T)+∫(Maximum R Luminance)×(D(T)/255)^{γ}(For All R Pixels) (6)

Deterioration Amount G(T+1)=Deterioration Amount G(T)+∫(Maximum G Luminance)×(D(T)/255)^{γ}(For All G Pixels) (7)

Deterioration Amount B(T+1)=Deterioration Amount B(T)+∫(Maximum B Luminance)×(D(T)/255)^{γ}(For All B Pixels) (8)

Moreover, the deterioration amount calculation unit 36 may multiply proportional coefficient parameters α1, α2, and α3 of luminance deterioration to the deterioration amount R, deterioration amount G, and deterioration amount B calculated by Equations (6), (7), and (8) to thereby obtain the luminance deterioration amounts of the respective colors RGB. Moreover, as the driving time of the display panel, the lighting time of the display panel or the power-ON time of the image display device can be used.

The luminance deterioration amounts of the respective colors RGB may be calculated in accordance with the deterioration characteristics of the OLED element or the TFT regardless of the above. For example, as a modified example, computation which does not take the video signal into consideration, computation which uses only a general time counter, and the like can be used.

The multiplier 38 corrects the V-L characteristic data of the respective colors RGB input from the multiplier 34 based on the luminance deterioration amounts of the respective colors RGB calculated by the deterioration amount calculation unit 36. Specifically, the luminance deterioration amounts of the respective colors RGB calculated by the deterioration amount calculation unit 36 are multiplied to the V-L characteristic data of the respective colors RGB input from the multiplier 34. Moreover, the multiplier 38 outputs the V-L characteristic data of the respective colors RGB corrected in this way to the D-V calculation unit 28.

The D-V calculation unit 28 calculates D-V characteristic data of the respective colors RGB based on the V-L table R, V-L table G, and V-L table B which are the corrected V-L characteristic data of the respective colors RGB input from the multiplier 38 and the R luminance (D), G luminance (D), and B luminance (D) which are D-L characteristic data of the respective colors RGB calculated by the D-L calculation unit 26. The other configurations are the same as those of the first and second embodiments.

Similarly to the first and second embodiments, the display setting values stored in the register 22 are frequently changed with changes in settings by users, changes in the use environment, and the like. When any one of the display setting values is changed, since the D-L characteristic data of the respective colors RGB calculated by the D-L calculation unit 26 are accordingly changed, the D-V characteristic data of the respective colors RGB calculated by the D-V calculation unit 28 are also changed. Moreover, the V-L characteristic data measured in advance of the display panel, stored in the storage unit 24 are reflected in the D-V characteristic data of the respective colors RGB calculated by the D-V calculation unit 28.

Therefore, according to the present embodiment, similarly to the first and second embodiments, it is also possible to dynamically control the D-V characteristics of the display panel while suppressing fluctuation in characteristic for each display panel. Furthermore, according to the present embodiment, it is possible to reflect the luminance deterioration amounts of the display panel in the D-V characteristics of the display panel, which are dynamically controlled.

In the present embodiment, although a method of correcting the V-L characteristic data of the respective colors RGB by multiplication has been described, the method of correction is not limited to multiplication. Moreover, the method of correcting the V-L characteristic data of the respective colors RGB based on the luminance deterioration amounts of the display panel may be applied to other embodiments as well as the first embodiment.

### Fourth Embodiment

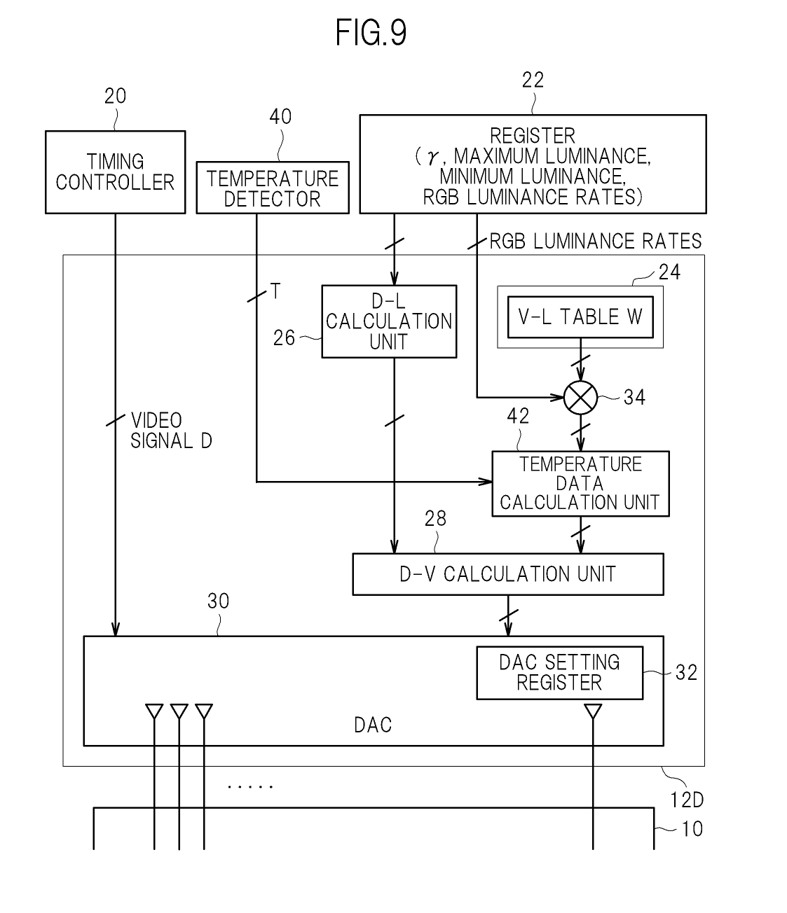

FIG. 9 is a block diagram of a signal line control circuit 12D according to the fourth embodiment of the present invention. As shown in FIG. 9, the signal line control circuit 12D includes a storage unit 24, a D-L calculation unit 26, a D-V calculation unit 28, a DAC 30, a multiplier 34, a temperature detector 40, and a temperature data calculation unit 42.

The signal line control circuit 12D is different from the signal line control circuit 12B according to the second embodiment, in that the configuration of acquiring the V-L characteristic data of the respective colors RGB is different. Specifically, the temperature detector 40 and the temperature data calculation unit 42 are added to the signal line control circuit 12B.

The V-L characteristics of the display panel are dependent on temperature. Thus, in the present embodiment, ambient temperature is detected, and the V-L characteristic data of the display panel are corrected.

The temperature detector 40 is disposed outside the display panel or at a position contacting the display panel so as to detect ambient temperature of the display panel. A thermistor, a thermocouple, a resistance temperature detector, and the like can be used as the temperature detector 40.

The temperature data calculation unit 42 corrects the V-L characteristic data of the respective colors RGB input from the multiplier 34 based on the ambient temperature detected by the temperature detector 40. For example, if the V-L characteristics of the display panel are substantially proportional to the ambient temperature T, and the V-L characteristic data of the respective colors RGB input from the multiplier 34 are data at temperature T0, the temperature data calculation unit 42 may correct the V-L characteristic data of the respective colors RGB in accordance with Equation (9) below.

L(V,T)=L(V,T0)×T/T0 (9)

The D-V calculation unit 28 calculates D-V characteristic data of the respective colors RGB based on the V-L table R, V-L table G, and V-L table B which are V-L characteristic data of the respective colors RGB corrected by the temperature data calculation unit 42 and the R luminance (D), G luminance (D), and B luminance (D) which are D-L characteristic data of the respective colors RGB calculated by the D-L calculation unit 26. The other configurations are the same as those of the first to third embodiments.

Similarly to the first to third embodiments, the display setting values stored in the register 22 are frequently changed with changes in settings by users, changes in the use environment, and the like. When any one of the display setting values is changed, since the D-L characteristic data of the respective colors RGB calculated by the D-L calculation unit 26 are accordingly changed, the D-V characteristic data of the respective colors RGB calculated by the D-V calculation unit 28 are also changed. Moreover, the V-L characteristic data measured in advance of the display panel, stored in the storage unit 24 are reflected in the D-V characteristic data of the respective colors RGB calculated by the D-V calculation unit 28.

Therefore, according to the present embodiment, similarly to the first to third embodiments, it is also possible to dynamically control the D-V characteristics of the display panel while suppressing fluctuation in characteristic for each display panel. Furthermore, according to the present embodiment, it is possible to reflect the temperature dependence of the display panel in the D-V characteristics of the display panel, which are dynamically controlled.

Moreover, the method of correcting the V-L characteristic data of the respective colors RGB based on the ambient temperature of the display panel may be applied to other embodiments as well as the first embodiment.

### Fifth Embodiment

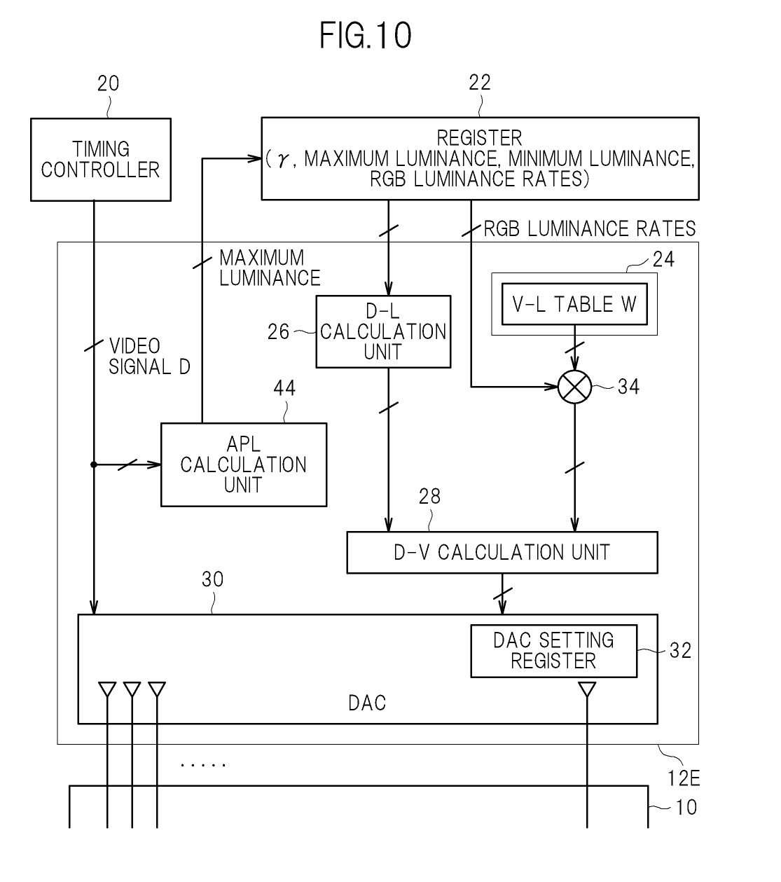

FIG. 10 is a block diagram of a signal line control circuit 12E according to the fifth embodiment of the present invention. As shown in FIG. 10, the signal line control circuit 12E includes a storage unit 24, a D-L calculation unit 26, a D-V calculation unit 28, a DAC 30, a multiplier 34, an average picture level (APL) calculation unit 44.

The signal line control circuit 12E is different from the signal line control circuit 12B according to the second embodiment, in that the configuration of updating the display setting values stored in the register 22 is different. That is, the APL calculation unit 44 is added.

The APL calculation unit 44 calculates an APL that represents the brightness of a picture per predetermined number of frames. For example, the APL calculation unit 44 calculates the APL representing the brightness of a picture of one frame in accordance with Equation (10) or (11) below.

APL=∫(Video Signals of All Pixels)(For One Frame) (10)

APL=∫(D/255)^{γ}(For All Pixels of One Frame) (11)

Although Equations (10) and (11) above are methods of calculating the APL for one frame, the sum of a plurality of frames may be used as the APL.

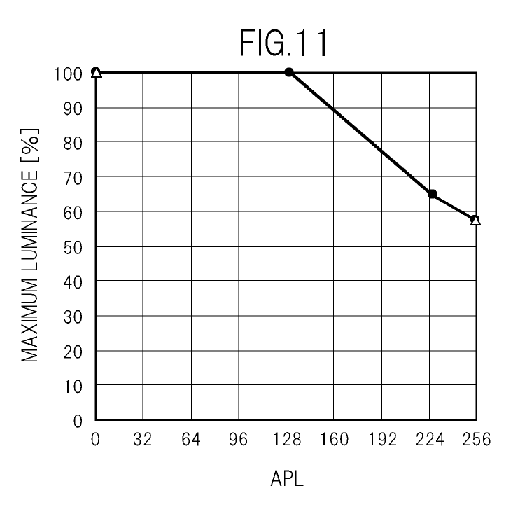

Moreover, the APL calculation unit 44 updates the maximum luminance stored in the register 22 in accordance with the calculated APL. For example, the APL calculation unit 44 controls the maximum luminance based on the calculated APL and the relationship between the APL and the maximum luminance shown in FIG. 11. As shown in FIG. 11, it is preferable to perform control of decreasing the maximum luminance when the APL is large. By doing so, it is possible to suppress an increase in power consumption when a picture is bright.

When the maximum luminance stored in the register 22 is updated by the APL calculation unit 44, the D-L calculation unit 26 recalculates the D-L characteristic data of the respective colors RGB.

The D-V calculation unit 28 calculates D-V characteristic data of the respective colors RGB based on the V-L table R, V-L table G, and V-L table B which are V-L characteristic data of the respective colors RGB input from the multiplier 34 and the R luminance (D), G luminance (D), and B luminance (D) which are D-L characteristic data of the respective colors RGB calculated by the D-L calculation unit 26. The other configurations are the same as those of the first to fourth embodiments.

In this way, when the maximum luminance stored in the register 22 is changed based on the APL, since the D-L characteristic data of the respective colors RGB calculated by the D-L calculation unit 26 are accordingly changed, the D-V characteristic data of the respective colors RGB calculated by the D-V calculation unit 28 are also changed. Moreover, the V-L characteristic data measured in advance of the display panel, stored in the storage unit 24 are reflected in the D-V characteristic data of the respective colors RGB calculated by the D-V calculation unit 28.

Therefore, according to the present embodiment, it is possible to dynamically control the D-V characteristics of the display panel in accordance with a change in the APL while suppressing fluctuation in characteristic for each display panel. Moreover, automatic brightness limiter (ABL) control can be performed by pulse amplitude modulation (PAM).

The method of dynamically controlling the D-V characteristics of the display panel in accordance with a change in the APL can be applied to other embodiments as well as the first embodiment.

### Sixth Embodiment

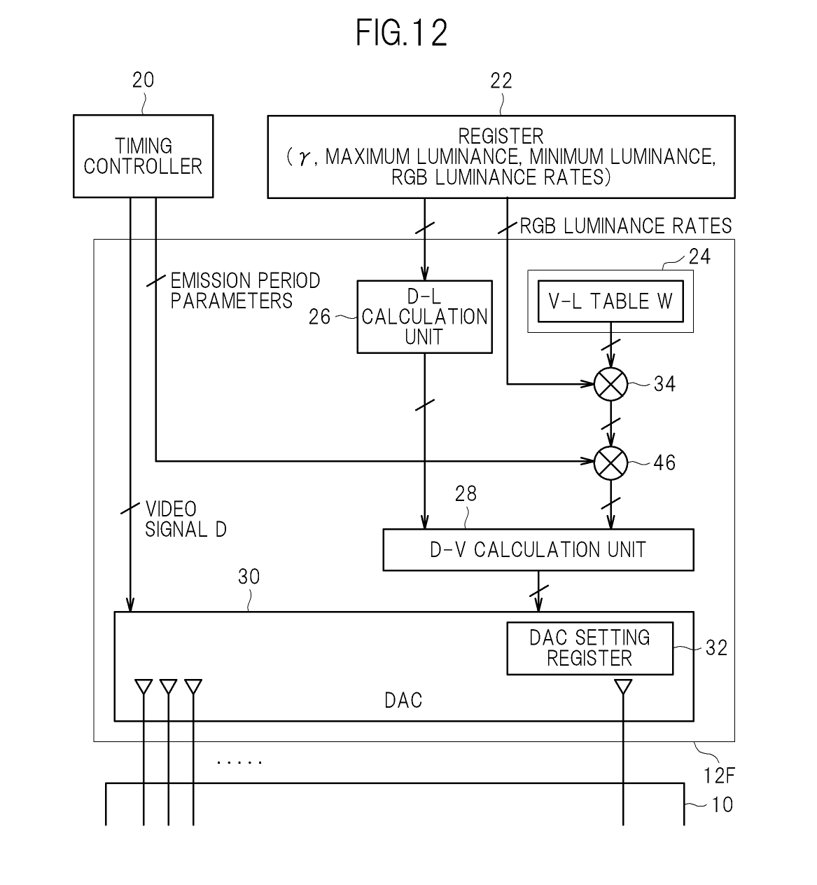

FIG. 12 is a block diagram of a signal line control circuit 12F according to the sixth embodiment of the present invention. As shown in FIG. 12, the signal line control circuit 12F includes a storage unit 24, a D-L calculation unit 26, a D-V calculation unit 28, a DAC 30, and multipliers 34 and 46.

The signal line control circuit 12F is different from the signal line control circuit 12B according to the second embodiment, in that the configuration of acquiring the V-L characteristic data of the respective colors RGB is different. Specifically, unlike the signal line control circuit 12B, emission period parameters are output from the timing controller 20, and the multiplier 46 are added.

Since the luminance of the display panel is proportional to the emission period of the display panel, if the emission period when measuring the V-L characteristics of the display panel is Duty0, and the present emission period is Duty, the emission period parameters output from the timing controller 20 are expressed by Equation (12) below.

Emission Period Parameter=Duty/Duty0 (12)

The multiplier 46 corrects the V-L characteristic data of the respective colors RGB input from the multiplier 34 based on the emission period parameters input from the timing controller 20. Specifically, the emission period parameters input from the timing controller 20 are multiplied to the V-L characteristic data of the respective colors RGB input from the multiplier 34. Moreover, the multiplier 46 outputs the V-L characteristic data of the respective colors RGB corrected in this way to the D-V calculation unit 28.

The D-V calculation unit 28 calculates D-V characteristic data of the respective colors RGB based on the V-L table R, V-L table G, and V-L table B which are the corrected V-L characteristic data of the respective colors RGB input from the multiplier 46 and the R luminance (D), G luminance (D), and B luminance (D) which are D-L characteristic data of the respective colors RGB calculated by the D-L calculation unit 26. The other configurations are the same as those of the first to fifth embodiments.

Similarly to the first to fifth embodiments, the display setting values stored in the register 22 are frequently changed with changes in settings by users, changes in the use environment, and the like. When any one of the display setting values is changed, since the D-L characteristic data of the respective colors RGB calculated by the D-L calculation unit 26 are accordingly changed, the D-V characteristic data of the respective colors RGB calculated by the D-V calculation unit 28 are also changed. Moreover, the V-L characteristic data measured in advance of the display panel, stored in the storage unit 24 are reflected in the D-V characteristic data of the respective colors RGB calculated by the D-V calculation unit 28.

Therefore, according to the present embodiment, similarly to the first to fifth embodiments, it is also possible to dynamically control the D-V characteristics of the display panel while suppressing fluctuation in characteristic for each display panel. Furthermore, according to the present embodiment, when the emission period when measuring the V-L characteristics of the display panel is different from the present emission period, it is possible to compensate for the calculated D-V characteristics of the display panel based on the V-L characteristic data measured in advance.

The method of correcting the V-L characteristic data of the respective colors RGB based on the emission period parameters of the display panel may be applied to other embodiments as well as the first embodiment.

### Modified Example

The present invention is not limited to the above embodiments but various modifications can be made. Moreover, the configurations described in the above embodiments can be substituted with substantially the same configurations, configurations showing the same operational effects, or configurations capable of attaining the same objects.

For example, in the above embodiments, although the present invention has been applied to an image display device having an organic EL panel, the present invention can be applied to general image display devices in which fluctuation in characteristic for each display panel can cause problems, such as an image display device including a display panel which uses a self-luminous element.

What is claimed is:

1. An image display device comprising:
a display panel having a display region in which a plurality of pixels including a red (R) pixel, a green (G) pixel, and a blue (B) pixel are arranged;
a measurement value storage unit that stores V-L characteristic data representing the characteristics measured in advance of luminance against a driving voltage of the display panel;
a V-L acquisition unit that acquires V-L characteristic data of the respective colors RGB based on the V-L characteristic data stored in the measurement value storage unit;
a setting value storage unit that stores display setting values for setting display attributes of the display panel;
a D-L calculation unit that calculates D-L characteristic data for the respective colors RGB, representing the characteristics of luminance against a gradation of the display panel based on the display setting values stored in the setting value storage unit;
a D-V calculation unit that calculates D-V characteristic data for the respective colors RGB, representing the characteristics of the driving voltage against the gradation of the display panel based on the V-L characteristic data of the respective colors RGB acquired by the V-L acquisition unit and the D-L characteristic data of the respective colors RGB calculated by the D-L calculation unit; and
a driving voltage generation unit that generates a driving voltage corresponding to a video signal input from the outside based on the D-V characteristic data of the respective colors RGB calculated by the D-V calculation unit and applies the driving voltage to each of the plurality of pixels.

2. The image display device according to claim 1,
wherein the measurement value storage unit stores data representing the characteristics measured in advance of luminances of the respective colors RGB against the driving voltage of the display panel as the V-L characteristic data, and
wherein the V-L acquisition unit acquires the V-L characteristic data stored in the measurement value storage unit as the V-L characteristic data of the respective colors RGB.

3. The image display device according to claim 1, further comprising:
a luminance rate acquisition unit that acquires RGB luminance rates representing the rates of the luminances of the respective colors RGB to that of white of the display panel,
wherein the measurement value storage unit stores data representing the characteristics measured in advance of the luminance of white against the driving voltage of the display panel as the V-L characteristic data, and
wherein the V-L acquisition unit calculates the V-L characteristic data of the respective colors RGB based on the data representing the characteristics of the luminance of white against the driving voltage of the display panel stored in the measurement value storage unit and the RGB luminance rates acquired by the luminance rate acquisition unit.

4. The image display device according to claim 1, further comprising:
a deterioration amount calculation unit that calculates luminance deterioration amounts of the respective colors RGB of the display panel,
wherein the V-L acquisition unit corrects the V-L characteristic data of the respective colors RGB based on the luminance deterioration amounts of the respective colors RGB calculated by the deterioration amount calculation unit.

5. The image display device according to claim 4,
wherein the deterioration amount calculation unit calculates the luminance deterioration amounts of the respective colors RGB based on the product of the video signal and a driving time of the display panel.

6. The image display device according to claim 5,
wherein the driving time of the display panel is a lighting time of the display panel or a power-ON time of the image display device.

7. The image display device according to claim 1, further comprising:
a temperature detection unit that detects an ambient temperature of the display panel,
wherein the V-L acquisition unit corrects the V-L characteristic data of the respective colors RGB based on the ambient temperature detected by the temperature detection unit.

8. The image display device according to claim 1,
wherein the V-L acquisition unit corrects the V-L characteristic data of the respective colors RGB based on an emission period when measuring the V-L characteristics of the display panel and a present emission period of the display panel.

9. The image display device according to claim 1, further comprising:
a luminance rate acquisition unit that acquires RGB luminance rates representing the rates of the luminances of the respective colors RGB to that of white of the display panel,
wherein the setting value storage unit stores at least a gamma value, a maximum luminance, and a minimum luminance as the display setting values, and
wherein the D-L calculation unit calculates the D-L characteristic data of the respective colors RGB based on data representing the characteristics of the luminance of white against the gradation of the display panel, calculated based on the gamma value, the maximum luminance and the minimum luminance stored in the setting value storage unit and the RGB luminance rates acquired by the luminance rate acquisition unit.

10. The image display device according to claim 9,
wherein the setting value storage unit further stores a color temperature of white and chromaticities of the respective colors RGB, and
wherein the luminance rate acquisition unit calculates the RGB luminance rates based on the color temperature of white and the chromaticities of the respective colors RGB stored in the setting value storage unit.

11. The image display device according to claim 1,
wherein the D-L calculation unit recalculates the D-L characteristic data of the respective colors RGB at the time when any one of the display setting values stored in the setting value storage unit is changed.

12. The image display device according to claim 1,
wherein the driving voltage generation unit is a D/A converter that operates in accordance with the content set in a setting register, and
wherein the D-V calculation unit sets the calculated D-V characteristic data of the respective colors RGB in the setting register.

13. The image display device according to claim 1,
wherein each of the plurality of pixels includes an organic light-emitting diode element.

14. A control method of an image display device which includes a display panel having a display region in which a plurality of pixels including a red (R) pixel, a green (G) pixel, and a blue (B) pixel are arranged, comprising:
storing V-L characteristic data representing the characteristics measured in advance of luminance against a driving voltage of the display panel in a measurement value storage unit;
acquiring V-L characteristic data of the respective colors RGB based on the V-L characteristic data stored in the measurement value storage unit;
storing display setting values for setting display attributes of the display panel in a setting value storage unit;
calculating D-L characteristic data for the respective colors RGB, representing the characteristics of luminance against a gradation of the display panel based on the display setting values stored in the setting value storage unit;
calculating D-V characteristic data for the respective colors RGB, representing the characteristics of a driving voltage against the gradation of the display panel based on the V-L characteristic data of the respective colors RGB and the D-L characteristic data of the respective colors RGB; and
generating a driving voltage corresponding to a video signal input from the outside based on the D-V characteristic data of the respective colors RGB and applying the driving voltage to each of the plurality of pixels.
